(19) United States
(12) Patent Application Publication
(10) Pub. No.: US 2001/0048464 A1
(43) Pub. Date: Dec. 6, 2001

(54) Portable videoconferencing system

(76) Inventor: Howard S. Barnett, Plano, TX (US)

Correspondence Address: The White House on Turtle Creek, 2401 Turtle Creek Blvd, Dallas, TX, 75219-4760, US

(21) Appl. No.: 09/827,547

(22) Filed: Apr. 6, 2001

Related U.S. Application Data
(60) Provisional application No. 60/195,377, filed on Apr. 7, 2000.

(51) Int. Cl. H04N 7/14

(52) U.S. Cl. 348/14.08

(57) ABSTRACT

A system for teleconferencing presentations by a presenter is disclosed, including a cart forming a podium, a computer in or on the cart, a touch panel interface with the computer, positioned on the cart, visible to the presenter; and a CODEC operationally attached to the computer. One arrangement includes a first camera for taking a video image of the presenter, mounted on the cart, and a second camera, mounted on the cart, for taking images of documents. In one preferred arrangement, the system also includes a projector associated with the cart and a screen. The projector projects images from the first or second camera to the screen.

### BACKGROUND OF THE INVENTION

1. Field of the Invention

The present invention relates generally to the field communications and in particular to the field of videoconferencing.

2. Description of Related Art

Videoconferencing has been performed using cumbersome equipment. The traditional videoconferencing equipment has been, one or two video monitors on carts with a video CODEC, microphones, speakers, camera. Optional cameras and devices that allow computer images to be displayed may be added as well. To move and operate this device requires that the user move one or two carts of equipment. The user must then position himself away from the equipment and operate it by a control that would be separate from the equipment. If the user wanted to attach another device to the equipment such as a document camera, then the user must attach the device and place the device on some surface or alternatively supply another cart.

### SUMMARY OF THE INVENTION

This invention allows the user to move and operate all equipment while it remains on one cart. The advantage makes for a more portable videoconferencing device which can be well suited for distance education.

In a preferred embodiment of the invention we see several different components. A CODEC sends and receives compressed video images. In the preferred embodiment, the CODEC is internal to a PC. This allows a user to control the functionality of the CODEC using the computer. Among the features that the control can perform are, volume control, camera selection and control, VCR selection, microphone muting, speaker muting, transmission muting. A Display is a touch panel interface to the PC for control of the programs that are executed in the PC and for control of the CODEC. Also attached to the computer is a keyboard and mouse. In a preferred embodiment, the keyboard and mouse are attached using an infrared link. Speakers being mounted allows the PC to audio to be heard as well as the audio from the videoconference or the VCR. A VCR can record an ongoing videoconference as well as playback a VCR recording for local or local and remote viewing. The first camera is designed to video the audience or the instructor. The camera is attached from a chord emerging from the cart and is mounted on a Tripod. The cord is of sufficient length to place the camera next to a screen. The second camera is a high quality document camera. The camera is inside a drawer in the system in one embodiment. A microphone 24 can be located away from the main videoconferencing unit. The microphone and camera are tethered to the unit by the cables in this embodiment but the either or both can be connected by any other means. The videoconference can be viewed by using the projector to project an image on the screen. Optionally a second projector can be added and even a third (not shown). With three projectors, during a conference, the distant end can always be seen as well as the local end and an any data being shared. As the projector quantity is reduced, the functionality of seeing the distant end, local end and the data can still be accomplished with use of picture-in-picture as well as use of putting the video picture on the data window.

A cart allows for easy transport of all the equipment from one location to another. The cart is designed as a teacher's podium. The positioning of the equipment allows the system to be used without removing it from the cart. The projector(s) is on a swivel to allow it to be moved from being over the podium to being away from the speakers control arena. The swivels allow the projectors to be moved and adjusted to different heights so that the image can be projected to any position. There is control and space in the work area that allow the instructor to run the equipment from this location.

Portability is further enhanced in the preferred embodiment by use of videoconferencing over computer network rather than traditional telco interfaces, those being T1, V.35 or RS-422. This allows the equipment to be moved into rooms where no special preparation is required for videoconferencing.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is a diagrammatic representation of a videoconferencing system according to the present invention; and

FIG. 2 is a front perspective view of an alternative embodiment of a videoconferencing system according to the present invention.

### DESCRIPTION OF THE PREFERRED EMBODIMENT

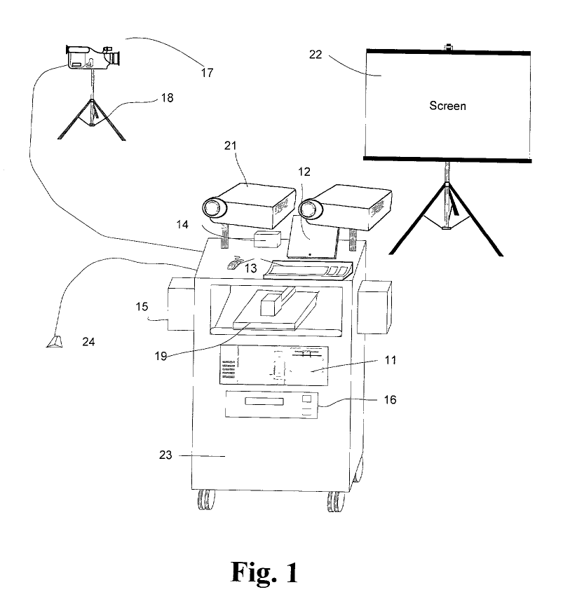

Referring now to the drawing, and in particular to FIG. 1, in a preferred embodiment of the invention, referred to generally by reference numeral 10, we see several different components. A CODEC 11 sends and receives compressed video images. CODEC 11 is internal to a PC. This allows a user to control the functionality of the CODEC using the computer. Among the features that the control can perform are, volume control, camera selection and control, VCR selection, microphone muting, speaker muting, transmission muting. A Display 12 is a touch panel interface to the PC for control of the programs that are executed in the PC and for control of the CODEC. Also attached to the computer is a keyboard and mouse 13. In a preferred embodiment, the keyboard and mouse 13 are attached using an infrared link 14. Speakers 15, being mounted, allow the PC to audio to be heard as well as the audio from the videoconference or a VCR 16. VCR 16 can record an ongoing videoconference as well as playback a VCR recording for local or local and remote viewing. A first camera 17 is designed to video the audience or the instructor. Fisrt camera 17 is attached from a chord emerging from the cart and is mounted on a tripod 18. The cord is of sufficient length to place the first camera next to a screen. A second camera 19 is a high quality document camera. The second camera is inside a drawer in the system. A microphone 20 can be located away from the main videoconferencing unit. The microphone and the second camera are tethered to the unit by the cables in this embodiment but the either or both can be connected by any other means. Two cameras are shown in this preferred embodiment, although more can be easily achieved.

The videoconference can be viewed by using a projector 21 to project an image on a screen 22. Optionally a second projector can be added and even a third (not shown). With three projectors, during a conference, the distant end can always be seen as well as the local end and an any data being shared. As the projector quantity is reduced, the functionality of seeing the distant end, local end and the data can still be accomplished with use of picture-in-picture as well as use of putting the video picture on the data window.

A cart 23 allows for easy transport of all the equipment from one location to another. The cart is designed as a teacher's podium. The positioning of the equipment allows the system to be used without removing it from the cart. The projector(s) is on a swivel to allow it to be moved from being over the podium to being away from the speakers control arena. The swivels allow the projectors to be moved and adjusted to different heights so that the image can be projected to any position. There is control and space in the work area that allow the instructor to run the equipment from this location.

Portability is further enhanced in the preferred embodiment by use of videoconferencing over computer network rather than traditional telco interfaces, those being T1, V.35 or RS-422. This allows the equipment to be moved into rooms where no special preparation is required for videoconferencing.

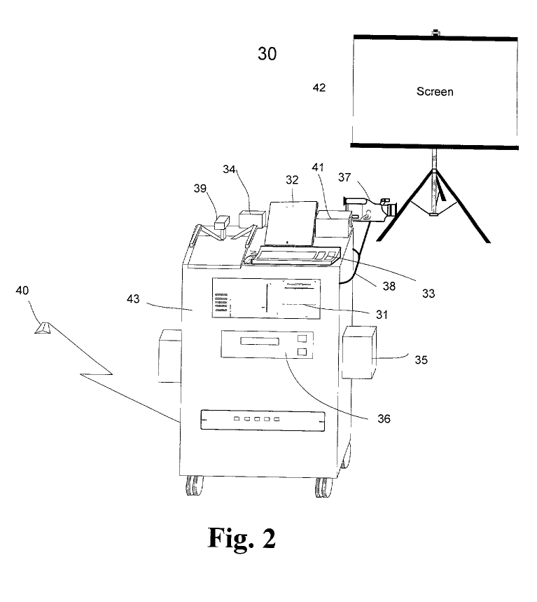

Referring now to FIG. 2, a second preferred embodiment of the invention is referred to generally by reference numeral 30. A cart 43 A CODEC 31, not shown, sends and receives compressed video images. CODEC 31 is internal to a PC located inside the cart. A Display 32 is a touch panel interface to the PC for control of the programs that are executed in the PC and for control of the CODEC. Also attached to the computer is a keyboard and mouse 33, not shown. In a preferred embodiment, the keyboard and mouse 33 are attached using an infrared link 34, not shown. Speakers 35 are mounted on the audience side of the cart, allowing the PC audio to be heard as well as the audio from the videoconference or a VCR 36, located in the cart. VCR 36 can record an ongoing videoconference as well as playback a VCR recording for local or local and remote viewing. A first camera 37 is designed to video the audience or the instructor. Fisrt camera 37 is attached from a chord emerging from the cart and is mounted on a cart handle 38. A second camera 39 is a high quality document camera. The second camera is mounted on top of the cart. A microphone 40 can be located away from the cart or included on it, such as part of first camera 37. Two cameras are shown in this preferred embodiment, although more can be easily achieved.

The videoconference can be viewed by using a projector 41, not shown, to project an image on a screen 42, not shown, in a manner shown in the prior embodiment. Optionally a second projector can be added and even a third (not shown). With three projectors, during a conference, the distant end can always be seen as well as the local end and an any data being shared. As the projector quantity is reduced, the functionality of seeing the distant end, local end and the data can still be accomplished with use of picture-in-picture as well as use of putting the video picture on the data window.

A cart 43 allows for easy transport of all the equipment from one location to another. The cart is designed as a teacher's podium. The positioning of the equipment allows the system to be used without removing it from the cart. The projector(s) is on a swivel to allow it to be moved from being over the podium to being away from the speakers control arena. The swivels allow the projectors to be moved and adjusted to different heights so that the image can be projected to any position. There is control and space in the work area that allow the instructor to run the equipment from this location.

Advantages of the system of this invention over other previously designed systems includes:

1. Podium design vs. monitor cart design. The present invention puts the monitor and camera on the cart. Going to a projector system and properly engineering the cart offers a portable podium. The advantages to this are clear, no need for another cart to serve as a podium to contain document cameras and VCRs, Easy setup, with tethered or wireless connection, there is no rewiring as the device moves. Fewer components to move when relocating this from one place to another.

2. Single cart portability for multiple projections. Because we are using projectors we can display multiple videos from the same podium.

3. Ease of movement, because of the optional use of standard TCP/IP connectivity rather than the telco connectivity that has been state of the art, this can go into classrooms that have not previously been defined for videoconferencing

4. Optional Active Matrix display, allowing a reduction of the tabletop real estate that can be used. And allowing the PC monitor to double as a control panel allows both PC functionality as well as videoconference control. This is rare but not unknown in the art.

5. Muliple use. Because of the integrated PC, this system can also be a teaching or presenting system without videoconferencing.

In short the main asset for the design is the integration as a podium rather than as a monitor cart. This makes a total teaching platform much more portable than ever before. This is accomplished by an innovative cart design, the use of projectors rather than monitors, and easy access to removing and deploying the conference room camera as well as the microphones. When this is rolled into a room, in the preferred embodiment, all the instructor has to do to teach a class is, plug in power, plug into a standard computer network connection, set up the tripod for the camera, move the microphone(s) out, swivel out the projectors, slide out the document camera (if required) and teach.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A system for teleconferencing presentations by a presenter, comprising in combination:
a cart forming a podium;
a computer in or on the cart;
a touch panel interface with the computer, positioned on the cart, visible to the presenter; and
a CODEC operationally attached to the computer.

2. A system according to claim 1, further comprising a first camera for taking a video image of the presenter.

3. A system according to claim 2 wherein the first camera is mounted on the cart.

4. A system according to claim 2, further comprising a second camera, mounted on the cart, for taking images of documents.

5. A system according to claim 4, further comprising a projector associated with the cart and a screen, wherein the projector projects images from the first or second camera to the screen.
